(19) United States
(12) Patent Application Publication
(10) Pub. No.: US 2009/0176399 A1
(43) Pub. Date: Jul. 9, 2009

(54) Connector with a Dismount Latch Configured to Separate Unlatching From Cable Separation and Method of Release

(75) Inventors: Norman Bruce Desrosiers, Oxford, NC (US); Dean Frederick Herring, Youngsville, NC (US); Daniel Paul Kelaher, Holly Springs, NC (US); Paul Andrew Wormsbecher, Apex, NC (US)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(73) Assignee: INTERNATIONAL BUSINESS MACHINES CORPORATION, Armonk, NY (US)

(21) Appl. No.: 11/971,032

(22) Filed: Jan. 8, 2008

(51) Int. Cl. H01R 13/625

(52) U.S. Cl. 439/345

(57) ABSTRACT

A connector with a dismount latch configured to separate unlatching from cable separation and method of release. A connector includes a housing having an interconnect end and a rear end, the front end configured for interfacing with a reciprocal connector in a linear motion to engage and disengage the reciprocal connector. A latch is held by the housing, wherein the latch includes support arms extending at the rear end of the housing and engaging ends proximate the interconnect end for maintaining the housing relative to the reciprocal connector when in an engaged position. An actuator is rotatably mounted within support arms of the latch for translating a force transverse to the direction of the linear motion and applying the translated force to the latch to move the engaging ends of the latch.

### BACKGROUND

1. Fields of the Embodiments of the Invention

This invention relates in general to cable connectors, and more particularly to a connector with a dismount latch configured to separate unlatching from cable separation and method of release.

2. Description of Related Art

Storage devices are widely used in computers and data processing systems for storing information in digital form. As computer use continues to increase, there is a corresponding increase in the need to find sufficient storage volume for a greater number of disk drives, or other storage devices. Often a large number of storage devices are packaged together in close proximity to each other in mass storage systems.

Connectors between devices in computer servers and memory storage racks are a critical component. Connectors must be designed so that the contacts do not become disconnected when subjected to different loads and stresses, such as those imposed by vibration, temperature differences and the like. In addition, the connector should be relatively easy to connect and disconnect, especially within the confined space of a densely populated electronics rack cabinet.

Connectors often include latches for connection and disconnection to meet such requirements. Such latches ensure that mated contacts remain reliably closed and are prevented from opening during operation of the electronic assembly in which they are used. For disconnection, the latches must be disengaged. Initially, this was achieved by either unscrewing captive screws or pressing a pair of tabs on the latches at each side of the connector towards the center of the connector and then moving the connector to disconnect it. However, the space available for these tabs are usually small and the tabs may be difficult to grasp by a person removing the connector.

The connector must be disconnected from a port when a connector is designed to hook into the port header in such a way that any stress on the coupling will not allow for a clean dismount. Such a scenario exists with many high-speed signal cable designs today.

Many contemporary connector designs include a simple pull-back release with a pull-tab that is used to disconnect this connector from the port. The design intent is that the pull tab is simply pulled rearward to release the latches from the connector. However, the pull tab on the release actually makes disconnection difficult because the rearward force on the pull tab both unlatches the connector and disconnects the connector from the port at the same time. When the connector is pulled back by the release tab the entire connector wants to move away from the connector, and the hooks dig into the connector more tightly, which prevents the release of the cable. Essentially, the pull tab is allowing the disconnection step to happen before the unlatching step, which is physically impossible.

This problem is overcome today by pushing in the cable connector towards the connector and then pulling back on the connector pull tab. This process is inherently a two handed dismount. Moreover, the forward push and rearward pull on the tab allows the unlatching step to happen before the disconnection step. However, this removal method is very unintuitive.

It can be seen then that there is a need for a connector with a dismount latch that allows separation of the unlatching step from the cable separation step and thereby an improved method of release.

### SUMMARY OF THE EMBODIMENTS OF THE PRESENT INVENTION

To overcome the limitations in the prior art described above, and to overcome other limitations that will become apparent upon reading and understanding the present specification, embodiments of the present invention include a connector with a dismount latch configured to separate unlatching from cable separation and method of release.

Embodiments of the present invention enable the first motion of the connector release to be that of pushing down instead of pulling away from the connector bulkhead which cams the cable connector out of the port on the system. This separates the unlatching step from the cable disconnection step and prevents the disconnection step from preceding the unlatching step.

A connector according to an embodiment of the present invention includes a housing having an interconnect end and a rear end, the front end configured for interfacing with a reciprocal connector in a linear motion to engage and disengage the reciprocal connector, a latch held by said housing, the latch having support arms extending at the rear end of the housing and engaging ends proximate the interconnect end for maintaining the housing relative to the reciprocal connector when in an engaged position and an actuator rotatably mounted within support arms of the latch for translating a force transverse to the direction of the linear motion and applying the translated force to the latch to move the engaging ends of the latch.

In another embodiment of the present invention, a method for releasing a connector is provided. The method includes applying, to a release actuator coupled to a housing of a connector, a force transverse to a direction of the linear motion for removing the housing of the connector to a latch to move engaging ends of the latch to unlock the connector and while applying the transverse force to the actuator, moving the housing of the connector in the direction of linear motion for removing the housing.

These and various other advantages and features of novelty which characterize the embodiments of the present invention are pointed out with particularity in the claims annexed hereto and form a part hereof. However, for a better understanding of the embodiments of the present invention, their advantages, and the objects obtained by their use, reference should be made to the drawings which form a further part hereof, and to accompanying descriptive matter, in which there are illustrated and described specific embodiments of the present invention.

### BRIEF DESCRIPTION OF THE DRAWINGS

Referring now to the drawings in which like reference numbers represent corresponding parts throughout:

FIG. 1 illustrates a connector as known in the prior art having a release latch 110 for disconnecting the connector from a port;

FIG. 2 illustrates an operation of the connector for engaging a connector port as known in the prior art;

FIG. 3 illustrates a connector in an unlocked position as known in the prior art;

FIG. 4 shows a port header for engaging a connector according to an embodiment of the present invention;

FIG. 5 is a comparison drawing illustrating differences between a connector according to an embodiment of the present invention and a connector requiring the two-handed disconnect procedure;

FIG. 6 is a side view of connector showing additional detail of the rotatable latch according to an embodiment of the present invention;

FIG. 7 is a front perspective view of the connector of FIG. 6 according to an embodiment of the present invention; and

FIG. 8 is a close-up drawing of a camming handle used in the connector of FIGS. 6 and 7 according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the embodiments of the present invention.

Embodiments of the present invention provide a connector with a dismount latch configured to separate unlatching from cable separation and method of release. The first motion of the connector release may thus be that of pushing down instead of pulling away from the connector bulkhead in order to cam the cable connector out of the port. This separates the unlatching step from the cable disconnection step and prevents the disconnection step from preceding the unlatching step.

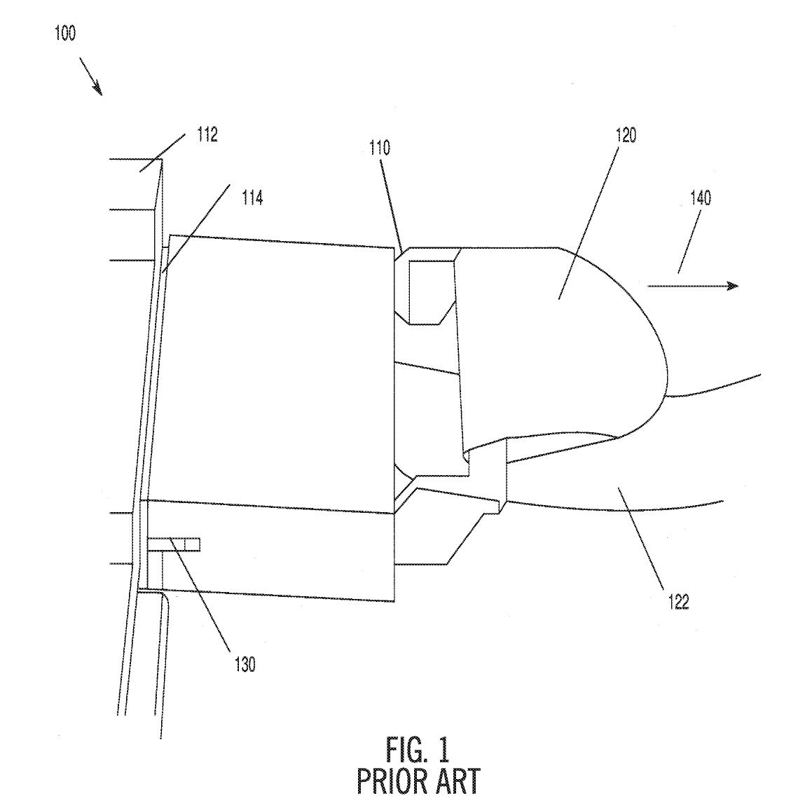

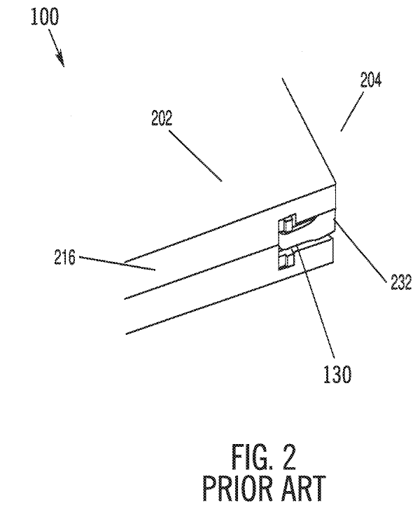

FIG. 1 illustrates a connector 100 as known in the prior art having a release latch 110 for disconnecting the connector 100 from a port. The connector 100 is shown connected to a device 112, wherein the connector 100 is hooked into the port header 114. However, the connector 100 is configured in such a way that any stress on the coupling will not allow for a clean dismount. Unfortunately, this design is found on many of today's high-speed signal cable connectors.

In FIG. 1, a pull-back release latch 110 is shown. The pull-back release latch 110 includes a pull tab 120. To release the connector 100, the pull tab 120 is pulled rearward in the direction of arrow 140 to cause the latch 110 to release hooks 130 from the port header 114. However, the pull tab 120 on the release latch 110 actually makes disconnection difficult because the rearward force on the pull tab 120 both unlatches the connector 100 and disconnects the connector 100 from the port header 114 at the same time. When the release latch 110 is pulled back by the release tab 120 the entire connector 100 wants to move away from the port header 114, and the hooks 130 at the port header 114 engage the port header 114 more tightly, which prevents the release of the cable 122.

Thus, the pull tab 120 of the connector 10 shown in FIG. 1 allows the disconnection step to happen before the unlatching step. However, this is physically impossible and therefore results in disconnection issues, e.g., difficulty in releasing the connector from the port, damage to the connector, damage to the port, damage to the cable, etc. To overcome such disconnection issues, and specifically to prevent such damage, users of the connector 100 push the cable connector 100 towards the port header 114 and then pull back on the connector pull tab 120 before finally pulling the cable connector 100 away from the port header 114. Nevertheless, this unintuitive method is a two handed dismount because of the forward push on the connector 100 and the rearward pull on the tab 120. Moreover, this two-handed process allows the unlatching step to happen before the disconnection step.

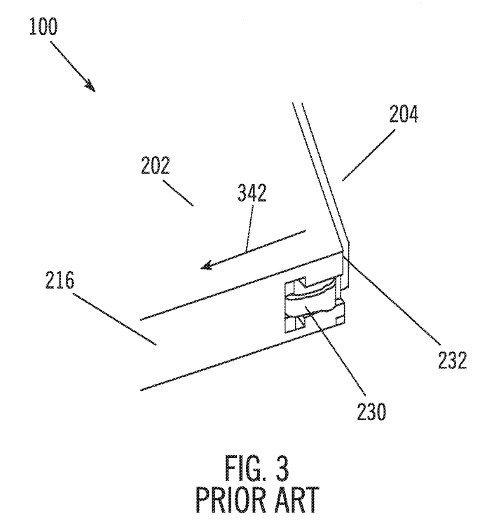

FIG. 2 illustrates an operation of the connector 100 as known in the prior art for engaging a connector port. The connector 100 includes a housing 202 and hooks 103 for coupling the electrical connector 100 to a receptacle (not shown). The housing 202 has a generally box-shaped form that is defined by an interconnect face 232 at the front end 204. The hooks 130 extend along the side walls 216 that define a cavity therein. A port header (not shown) extends at least partially within a cavity of the connector housing 202 at the front end 204. The hooks 130 are connected to a latch (see FIG. 1, 110). The hooks 130 are designed to provide the necessary retention to a port header.

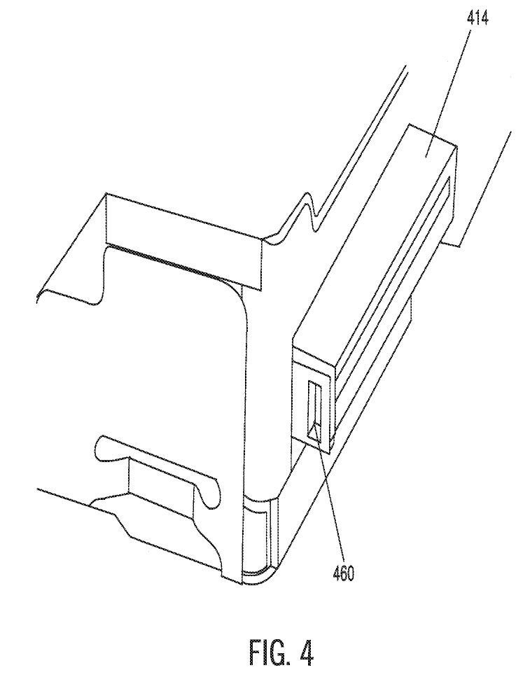

FIG. 3 illustrates the connector 100 as known in the prior art in an unlocked position. In FIG. 3, the connector 100 is again shown having a housing 202 and hooks 130 for coupling the electrical connector 100 to a port header (not shown). The housing 202 has a generally box-shaped form that is defined by an interconnect face 332 at the front end 204. The hooks 130 extend along the side walls 216 that define a cavity therein. In FIG. 3, the connector is in an unlocked state as provided by the hooks 130 being pulled away from the front end 204 of the housing 202. However, the movement of the hooks 130 away from the front 204 of the housing 202 (see arrow 342) while the housing is being forced in the same direction results in the jamming of the hooks 130.

FIG. 4 shows a port header 414 for engaging a connector according to an embodiment of the present invention. In FIG. 4, the port header 414 includes a receptacle 460 for receiving the hooks of the connector. The port header 414 is configured for being received within the housing of the connector and the hooks engage the receptacle 460 of the port header 414.

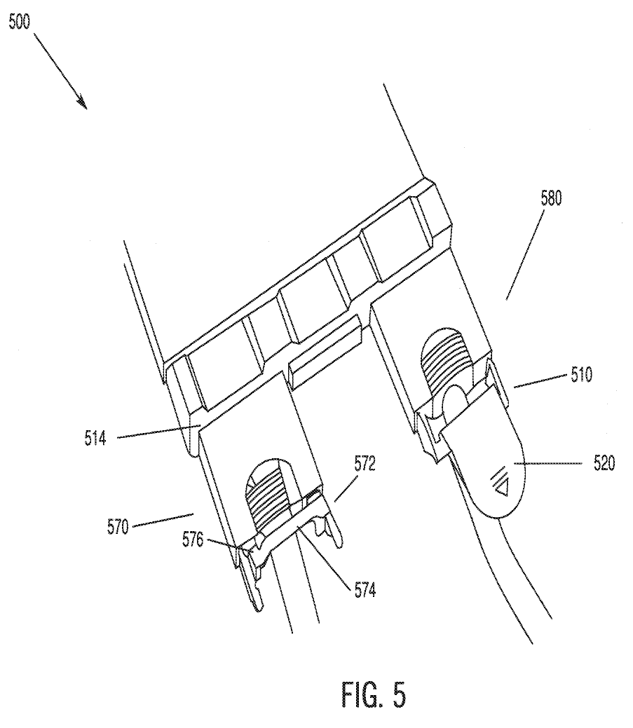

FIG. 5 is a comparison drawing 500 illustrating differences between a connector according to an embodiment of the present invention 570 and a connector requiring the two-handed disconnect procedure 580. In FIG. 5, the connector according to an embodiment of the present invention 570 includes a release mechanism 572 that redirects the first motion of the connector release to a pushing down motion instead of pulling away from the port header 514. This separates the unlatching step from the cable disconnection step and prevents the disconnection step from preceding the unlatching step.

The pull-back latch 510 of connector 580 is replaced by a rotatable latch 572 of connector 570 that requires a down motion. The rotatable latch 572 of connector 570 does not require the pull back tab 520. The pull-back latch 510 of connector 580 is replaced with a rotating cam handle 574 with a cam out tip 576. When pushing down on the rotating cam handle 574, the hook latch is not jammed into the latch receptacle thereby allowing easy release of the connector 570. With this method, it is not necessary to push the connector 570 towards the port header 514 while unlatching the connector 570. Moreover, the rotatable latch 572 of connector 570 provides a dismount process that may be accomplished with a one-handed motion that is less error-prone.

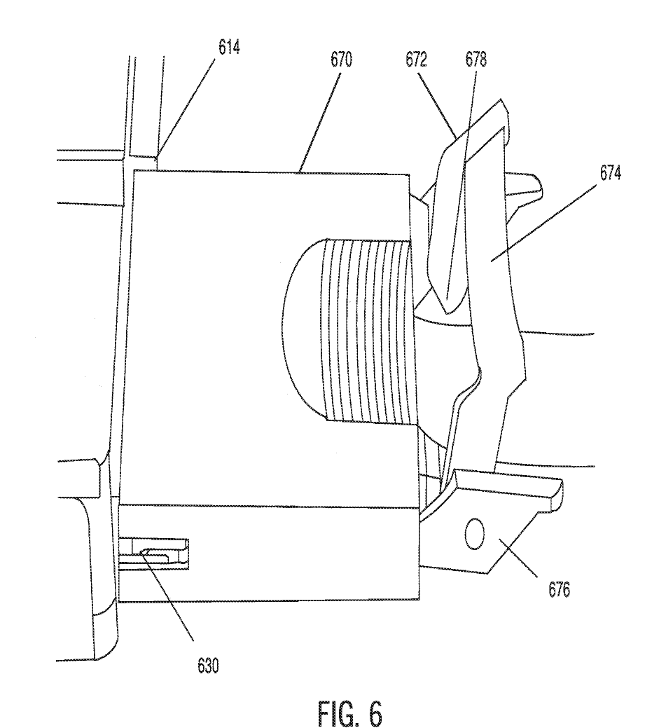

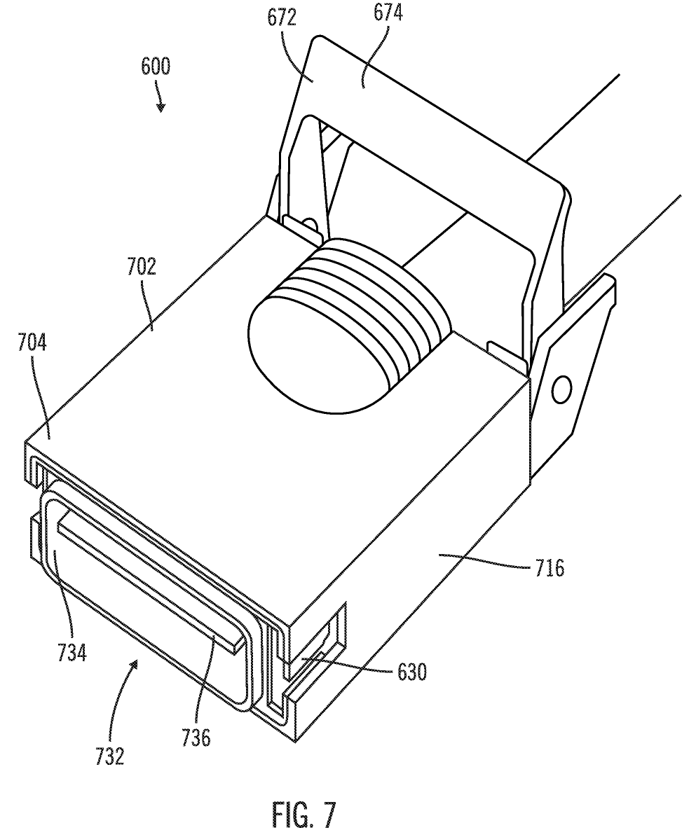

FIG. 6 is a side view of connector 670 showing additional detail of the rotatable latch 672 according to an embodiment of the present invention. In FIG. 6, the connector 670 is shown mated with a port header 614. The hooks 630 are locked into position to engage the receptacles (not shown) of the port header 614. The rotatable latch 672 includes an actuator, such as a rotatable handle 674, that is rotatably mounted in arms 676. The rotatable handle 674 may be pushed down to cause the camming end 678 of the rotatable handle 674 to pull back on the hooks 630 instead through the push down motion applied to the rotatable handle 674.

FIG. 7 is a front perspective view of the connector 600 according to an embodiment of the present invention. In FIG. 7, the connector 600 includes a housing 702 and hooks 630 for coupling the electrical connector 600 to a receptacle (not shown). The housing 702 has a generally box-shaped form that is defined by an interconnect face 732 at the front end 704. The hooks 630 extend along the side walls 716 that define a cavity therein. The housing 702 includes a cavity 734 at the front end 704 of the connector housing 702 for receiving a port header (not shown) or other reciprocal connector. A rotatable latch 672 redirects the first motion of the connector release to a pushing down motion instead of pulling away motion. This separates the unlatching step from the cable disconnection step and prevents the disconnection step from preceding the unlatching step. The rotatable latch 672 includes the rotating cam handle 674. In FIG. 7, electrical connections 736 are configured for being received in a port header as the port header is received within the cavity 734 of housing 702.

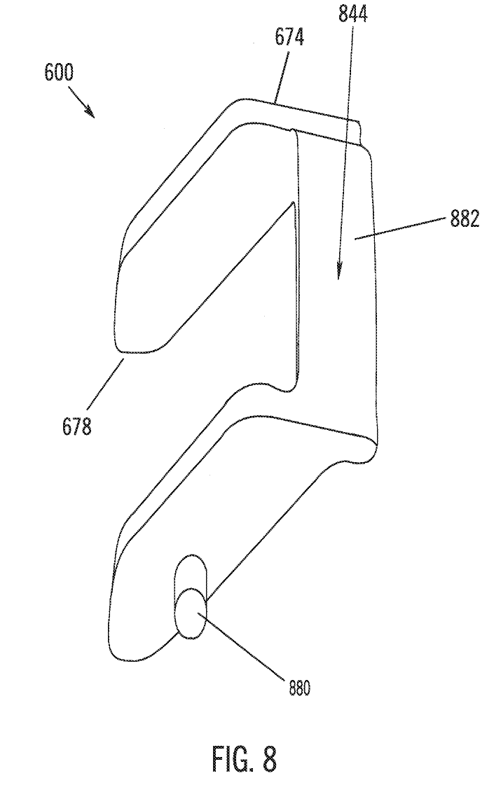

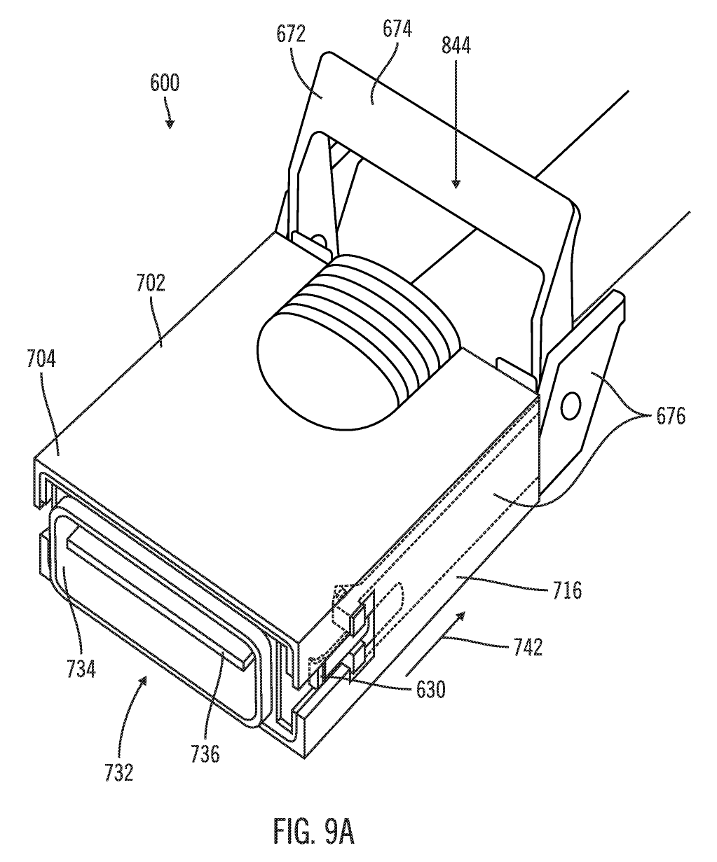

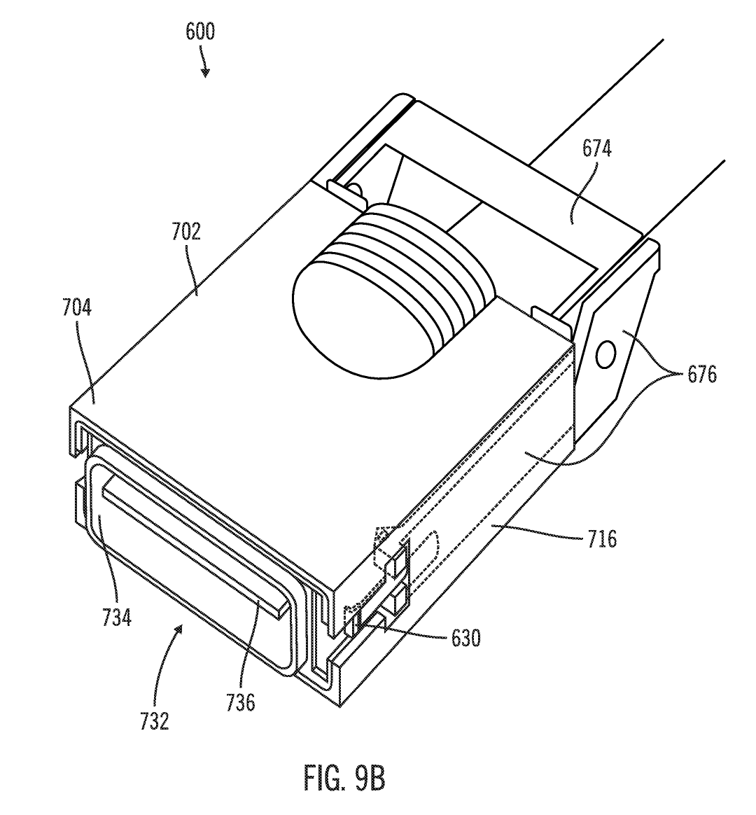

FIG. 8 is a close-up drawing 800 of a camming handle according to an embodiment of the present invention. In FIG. 8, the rotatable handle 674 is configured with a central shaft 880 for providing rotating motion to the rotatable handle 874 when a downward force (in direction of arrow 844) is applied to the crossbar 882 of the rotatable handle 674. The central shaft 880 mates with a shaft support structure in receiving arms (see FIG. 6, 676). When the rotatable handle 674 is pushed down to cause the camming end 878 of the rotatable handle 674 to pull back on the hook release tips 630 to release the connector.

FIG. 9A provides a view of FIG. 7 showing how arms 676 extend, as shown by the dotted lines, through the housing 702 to engage the hooks 630. In FIG. 9A, the hook 630 is not yet pulled back as the handle 674 is in an up position and the handle 674 is not yet pushed down to cause the camming end 678 to pull back on the arms 676 and the hook release tip 630. A downward force 844 is applied to the rotatable handle 674 as a result of the rotatable handle 674 being pushed down to have the arm 676 pull back on the release tips 630 as shown by pull back force 742.

FIG. 9B provides a view of FIG. 7 showing of how the rotatable handle 674 is in a down position as a result of the downward force 740 shown in FIG. 9B that causes the arms 676 to apply the pull back force 742 on the hook 630 to release the connector and place in the unlocked position.

Accordingly, a connector may be provided with a dismount latch configured to separate unlatching from cable separation according to embodiments of the present invention. The first motion of the connector release may be that of pushing down instead of pulling away from the connector bulkhead. This separates the unlatching step from the cable disconnection step and prevents the disconnection step from preceding the unlatching step.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. A connector for interfacing with a reciprocal connector, comprising:
a housing having a front end and a rear end, the front end configured for interfacing with the reciprocal connector in a first direction to engage and disengage the reciprocal connector;
a latch held by said housing, the latch having support arms extending at the rear end of the housing and hook tips proximate the interconnect end for maintaining the housing relative to the reciprocal connector when in an engaged position; and
an actuator rotatably mounted within support arms of the latch for translating a downward force in a second direction transverse with respect to the first direction and applying the translated downward force to the latch to move the support arms to pull back on the hook tips of the latch to disengage the housing from the reciprocal connector.

2. The connector of claim 1, wherein the translated downward force pulls the hook tips of the latch inward to release the housing from the reciprocal connector.

3. The connector of claim 1, wherein the actuator positions the hook tips of the latch outward to lock the housing to the reciprocal connector when the transverse downward force is not applied to the actuator.

4. The connector of claim 1, wherein the housing further comprises a wall, wherein the support arms extend in the housing at least partially between said front end and rear end to engage the hook tips.

5. The connector of claim 1, wherein the actuator mounted to the support arms is pivotable about a shaft having an axis transverse to the first direction for disengaging the housing from the reciprocal connector.

6. The connector of claim 1, wherein the actuator is configured with a cam having a curved cam surface.

7. The connector of claim 6, wherein pivoting of the actuator causes the cam surface to impinge upon said latch to impart linear translation movement to said latch to disengage the hook tips of the latch.

8. The connector of claim 1, wherein the actuator comprises a rotatable handle configured with a central shaft for providing rotating motion to the rotatable handle when the downward force is applied to the rotatable handle to cause a camming end of the rotatable handle to pull back on the hook tips of the latch to release the housing.

9. The connector of claim 1, wherein the hook tips are for coupling the reciprocal connector.

10. (canceled)

11. The connector of claim 1, wherein the actuator comprises a rotating cam handle.

12. A method for releasing a connector, comprising:
applying, to a release actuator coupled to a housing of a connector, a downward force in a second direction transverse to a first direction of the linear motion for removing the housing of the connector to a latch to move hook tips of the latch to unlock the connector;
while applying the transverse downward force to the actuator, moving the housing of the connector in the first direction for removing the housing.

13. The method of claim 12, wherein the applying the transverse downward force to the release actuator further comprises pulling the hook tips of the latch inward to release the housing from a reciprocal connector.

14. The method of claim 12 further comprises releasing the transverse force to cause the release actuator to position the hook tips of the latch outward to lock the housing to a reciprocal connector.

15. The method of claim 12, wherein the applying the transverse downward force to the release actuator further comprises pivoting a support arms about a shaft having an axis transverse to the first direction of the linear motion for disengaging the housing from a reciprocal connector.

16. The method of claim 12, wherein the applying the transverse downward force to the release actuator further comprises pivoting a support arm having a cam having a curved cam surface to causes the cam surface to impinge upon the latch to impart linear translation movement to said latch to disengage the engaging ends of the latch.

17. The method of claim 12, wherein the applying the transverse force to the release actuator further comprises rotating a rotatable handle configured with a central shaft when the transverse force is applied to the rotatable handle to cause a camming end of the rotatable handle to pull back on the hook tips of the latch to release the housing.

18. The method of claim 12, wherein the applying the transverse force to the release actuator further comprises releasing hook tips from the reciprocal connector.

19. The method of claim 12, wherein the applying the transverse force to the release actuator further comprises redirecting a first motion of the release actuator to a pushing down motion instead of pulling away motion.
